(19) United States
(12) Patent Application Publication
(10) Pub. No.: US 2024/0375948 A1
(43) Pub. Date: Nov. 14, 2024

(54) INSTALLATION POUR LA PRODUCTION DE H2

(71) Applicant: NOVACIUM, SOLAIZE (FR)

(72) Inventors: Jed KRAIEM, LYON (FR); Oleksiy NICHIPORUK, MIONS (FR); Julien DEGOULANGE, SAINT GENIS LAVAL (FR)

(21) Appl. No.: 18/660,455

(22) Filed: May 10, 2024

(30) Foreign Application Priority Data
May 12, 2023 (FR) 2304739

(51) Int. Cl. C01B 3/06

(52) U.S. Cl. CPC C01B 3/061; C01B 2203/025; C01B 2203/0266; C01B 2203/0883; C01B 2203/1205; C01B 2203/141; C01B 2203/148

(57) ABSTRACT

The present invention relates to an installation for the production of dihydrogen comprising:
a reaction enclosure (1) intended to contain an oxidizable material,
an alkaline solution feed system (2) fluidly connected to the reaction enclosure (1),
a pure water (31) supply system (3) fluidly connected to the reaction enclosure (1),
a dihydrogen collection system (4) downstream of the reaction enclosure (1), the collection system (4) being fluidly connected:
   to the reaction enclosure (1),
   to the supply system (3), and to
   a storage receptacle (5) configured to store the produced dihydrogen at a desired high pressure.

### FIELD OF THE INVENTION

The present invention relates to the general technical field of the production of dihydrogen H₂, more commonly called “hydrogen”.

In particular, the invention relates to an installation (and an associated method) for producing hydrogen under pressure by a chemical reaction, in particular by decomposition of water under the action of metals or metalloids.

### BACKGROUND OF THE INVENTION

### 1. Generalities

Hydrogen can be used in various applications due to its high energy potential. It can be converted into electricity, heat or motive power depending on the end use.

Not existing naturally, it must be manufactured from a primary energy source, then transported, stored and distributed to the user.

### 2. Existing Hydrogen Production Methods

Today, hydrogen can be produced from hydrocarbons by steam reforming of natural gas or by gasification of petroleum residues or coal. A disadvantage of hydrogen production methods by steam reforming is that they involve fossil resources.

Other methods for producing hydrogen, for example by electrolysis or by photocatalysis, have already been proposed. However, a disadvantage of these methods is that the hydrogen is produced under a relatively low pressure—typically comprised between 1 and 30 bars, so that a step of compressing the hydrogen is necessary to allow its loading into storage reservoirs. Moreover, these methods, and in particular electrolysis, are very energy-intensive.

Finally, methods for producing hydrogen using metals that decompose water under the action of an acid or a base are also known. In particular, document US 2003/0143155 discloses a method for producing hydrogen by corrosion of aluminum in water. This method includes the steps consisting of:
introducing an aqueous solution containing sodium hydroxide into a reaction receptacle,
introducing aluminum particles into the aqueous solution,
maintaining the aluminum particles on the surface of the aqueous solution,
reacting the aluminum particles with the water in the aqueous solution to produce hydrogen,
maintaining the amount of sodium hydroxide in the reaction receptacle substantially constant, and
obtaining an alumina precipitate in the bottom of the reaction receptacle.

A disadvantage of the method according to US 2003/0143155 relates to its significant production cost.

Indeed, when a reaction between aluminum and water is initiated, an impermeable alumina layer forms on the surface of the aluminum, and protects it from corrosion. This has the effect of slowing down or even stopping the corrosion reaction of the aluminum. It is therefore necessary to dissolve this alumina layer using an aqueous solution having a high pH, that is to say a high alkali concentration.

Thus, to implement the method described in document US 2003/0143155, the concentration of sodium hydroxide in the aqueous solution must be high. Therefore, the precipitation of alumina in the bottom of the reaction receptacle mentioned in US 2003/0143155, and the regeneration of sodium hydroxide which follows are limited. This results in consumption of sodium hydroxide during the aluminum corrosion reaction, and thus the need to regularly add sodium hydroxide to the reaction receptacle to maintain the aluminum corrosion reaction, which increases the cost of producing hydrogen from the method according to US 2003/0143155.

### 3. Purpose of the Invention

A purpose of the present invention is to propose an installation (and its associated method) for producing hydrogen allowing to overcome at least one of the aforementioned disadvantages.

In particular, a purpose of the present invention is to propose an installation configured to produce hydrogen under pressure, treat it, and fill a storage receptacle (such as a bottle) under pressure.

Another purpose of the present invention is to propose a hydrogen production installation to facilitate the management of reaction by-products.

Another purpose of the present invention is to provide an installation and a hydrogen production method allowing to obtain lower hydrogen production costs than those of the installations and methods of the prior art.

### BRIEF DESCRIPTION OF THE INVENTION

To this end, the invention proposes an installation for the production of dihydrogen comprising:
a reaction enclosure intended to contain an oxidizable material,
an alkaline solution feed system fluidly connected to the reaction enclosure,
a pure water supply system fluidly connected to the reaction enclosure,
a dihydrogen collection system downstream of the reaction enclosure, the collection system being fluidly connected:
   on the one hand to the reaction enclosure, and
   on the other hand to the supply system, and comprising a terminal for connecting a storage receptacle to the installation, said receptacle being configured to store the dihydrogen produced at a desired high pressure greater than or equal to 60 bars, preferably greater than 150 bars, even more preferably greater than 250 bars, in particular of the order of 350 bars,
      remarkable in that the reaction enclosure comprises:
a reaction chamber in which a corrosion reaction of the oxidizable material by the alkaline solution is carried out, said reaction producing a gas containing dihydrogen, and a reaction fluid composed of a mixture of alkaline solution and oxidized material,
a settling chamber in which a precipitation reaction of the oxidized material contained in the reaction fluid is carried out, and
a stirring unit fluidly connected to the reaction chamber and to the settling chamber to ensure the circulation of the reaction fluid between the reaction chamber and the settling chamber, the speed of circulation of the reaction fluid in the reaction chamber being greater than the speed of circulation of the reaction fluid in the settling chamber.

The fact that the reaction enclosure includes:
two separate chambers, namely:
   a first chamber—called a “reaction chamber”—in which the corrosion reaction of the oxidizable material (for example aluminum) is carried out, and
   a second chamber—called a “settling chamber”—in which the precipitation reaction of the oxidized material (for example sodium aluminate) is carried out, and
a stirring unit for ensuring the circulation of the reaction fluid through the first and second chambers, the speed of circulation of the reaction fluid in the first chamber (“reaction chamber”) being greater than the speed of circulation of the reaction fluid in the second chamber (“settling chamber”),
   allows on the one hand to attack the oxidizable material with an alkaline aqueous solution having a high pH ensuring the initiation and maintenance of the corrosion reaction of the oxidizable material with the water contained in the alkaline aqueous solution, and on the other hand to ensure precipitation of the oxidized material mainly in the settling chamber, that is to say in a compartment different from that in which the corrosion reaction takes place.

This arrangement ensures precipitation (for example in the form of alumina) of all the oxidized material produced (for example sodium aluminate), and therefore regeneration of the alkaline aqueous solution before its passage through the reaction chamber.

The device according to the invention thus allows the production of hydrogen without it being necessary to add alkali (such as sodium hydroxide (soda), potassium hydroxide (potash), lithium hydroxide, ammonium hydroxide (ammonia), etc.) during the corrosion reaction of the oxidizable material, which reduces the costs of producing hydrogen.

Preferred but non-limiting aspects of the device according to the invention are the following:
the power of the pump, the dimensions of the reaction chamber and the dimensions of the settling chamber can be configured so that:
   the circulation speed of the reaction fluid is greater than or equal to 5 cm/s in the reaction chamber, preferably greater than or equal to 6 cm/s, and
   the circulation speed of the reaction fluid is less than or equal to 4 cm/s in the settling chamber, preferably less than 3 cm/s;
the settling chamber may comprise a cyclone separation system;
the collection system can be fluidly connected to the reaction chamber of the reaction enclosure to receive the gas produced by the corrosion reaction of the oxidizable material, said collection system comprising a heat exchanger for condensing the water vapor contained in said gases and forming condensed pure water;
the collection system may further comprise a liquid sensor and a safety valve mounted between the reaction enclosure and the heat exchanger, the safety valve being:
   in a passing state when no liquid is detected by the liquid sensor so as to allow the circulation of gases between the reaction enclosure and the collection system,
   in a blocked state when a liquid is detected by the liquid sensor so as to prevent the circulation of gases from the reaction enclosure to the heat exchanger;
the collection system may further comprise a purifier mounted downstream of the heat exchanger to treat the gases coming from the heat exchanger;
the collection system may further comprise a spillway downstream of the heat exchanger, said spillway allowing the circulation of gases towards the storage receptacle when the pressure in the collection system is greater than or equal to the desired high pressure;
the collection system may comprise an isolation valve, said isolation valve being:
   in a blocked state:
      when the storage receptacle needs to be replaced, or
      during a start-up phase of the installation in which the reaction enclosure is filled with the alkaline solution,
   otherwise in a passing state;
the pure water supply system may comprise a tank containing pure water, and a transfer pump between said tank and the reaction enclosure, said transfer pump being configured to:
   transfer pure water from the tank to the reaction enclosure during a phase of recovery of dihydrogen contained in a gas pocket located in the reaction enclosure, between the alkaline aqueous solution and the gas collection system,
   transfer said pure water at a pressure greater than or equal to the desired high pressure;
the tank can be at atmospheric pressure, the supply system comprising a degassing valve, said degassing valve being:
   in a blocked state during the corrosion reaction of the oxidizable material by the alkaline solution, said reaction producing a gas containing dihydrogen,
   in a passing state when the corrosion reaction is completed, to reduce the pressure inside the reaction enclosure and inside the collection system;
the supply system may further comprise:
   an inlet valve between the collection system and the tank, said inlet valve being:
      in a blocked state during the corrosion reaction of the oxidizable material by the alkaline solution, so that the condensed pure water from the heat exchanger is redirected to the reaction enclosure,
      in a passing state when the corrosion reaction is completed, to allow the circulation of condensed pure water from the heat exchanger, from the collection system to the tank, and
   an outlet valve between the tank and the reaction enclosure, said outlet valve being in a passing state when the corrosion reaction is complete, for rinsing by-products of the corrosion reaction.

The invention also relates to a method for producing dihydrogen from an installation comprising:
a reaction enclosure intended to contain an oxidizable material, said enclosure including:
   a reaction chamber in which a corrosion reaction of the oxidizable material is carried out, said reaction producing a gas containing dihydrogen, and a reaction fluid containing oxidized material, and
   a settling chamber in which a reaction of precipitation of the oxidized material contained in the reaction fluid is carried out,
an alkaline solution feed system fluidly connected to the reaction enclosure,
a pure water supply system fluidly connected to the reaction enclosure,
a dihydrogen collection system downstream of the reaction enclosure, the collection system being fluidly connected to the reaction enclosure, and to the supply system, the collection system comprising a terminal for connecting a storage receptacle configured to store the dihydrogen produced at a desired high pressure greater than or equal to 60 bars, preferably greater than 150 bars, even more preferably greater than 250 bars, in particular of the order of 350 bars,
remarkable in that the method comprises a step of stirring the reaction fluid to ensure the circulation of the reaction fluid:
   at a first circulation speed in the reaction chamber, and
   at a second circulation speed in the settling chamber,
the second circulation speed being lower than the first circulation speed.

### BRIEF DESCRIPTION OF THE DRAWINGS

Other advantages and characteristics of the hydrogen production installation and its associated method will emerge better from the description which follows of several variants of execution, given by way of non-limiting examples, from the appended drawings on which:

FIG. 1 is a schematic representation of different functional groups constituting the hydrogen production installation,

FIG. 2 is a detailed schematic representation of a reaction enclosure,

FIG. 3 is a detailed schematic representation of an alkaline aqueous solution feed system,

FIG. 4 is a detailed schematic representation of a pure water supply system,

FIG. 5 is a detailed schematic representation of a hydrogen collection system,

FIGS. 6a to 6d illustrate the operating principle of the hydrogen production installation shown in FIG. 1.

### DETAILED DESCRIPTION OF THE INVENTION

Different examples of embodiment of the invention will now be described with reference to the figures. In these different figures, the equivalent elements are designated by the same numerical reference.

### 1. General Presentation

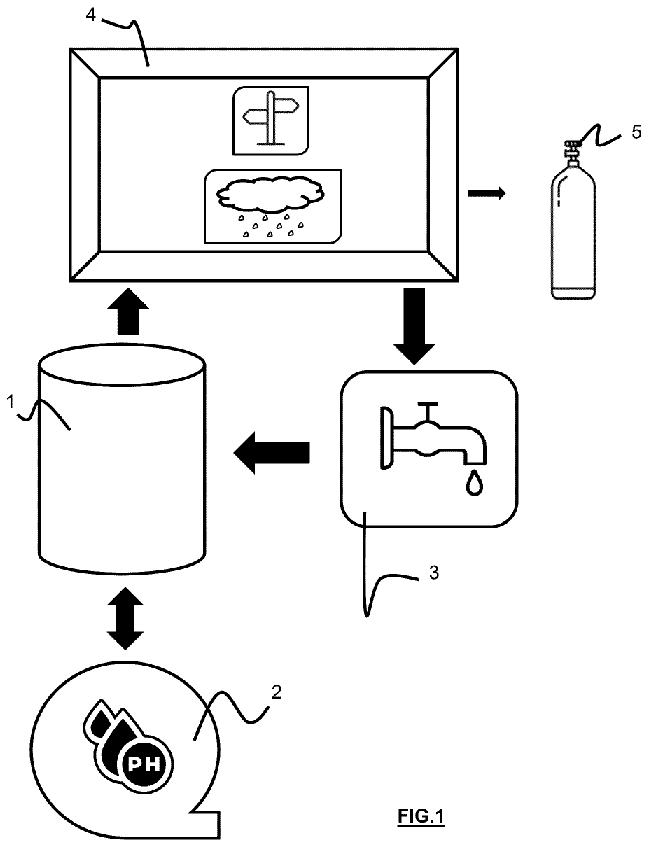

With reference to FIG. 1, the installation is made up of different groups each having a specific function in the context of hydrogen production.

In particular, the installation comprises:
a reaction enclosure 1,
an alkaline aqueous solution feed system 2 upstream of the reaction enclosure,
a pure water supply system 3 downstream of the alkaline aqueous solution feed system,
a hydrogen collection system 4 downstream of the reaction enclosure,
a control unit (not shown) to control the different components of the reaction enclosure 1, the feed system 2, the supply system 3 and the collection system 4.

The reaction enclosure 1 allows the implementation of a corrosion reaction of an oxidizable material with the water contained in the alkaline aqueous solution.

The alkaline aqueous solution feed system 2 allows:
to inject the alkaline aqueous solution into the reaction enclosure 1 at the start of the reaction in order to fill the reaction enclosure with the alkaline aqueous solution, and
to extract the alkaline aqueous solution contained in the reaction enclosure 1 at the end of the reaction in order to empty the reaction enclosure 1.

The pure water supply system 3 allows to inject pure water into the reaction enclosure 1 at the end of the reaction in order to:
to limit the losses of hydrogen produced (elimination of a gaseous sky contained in the reaction enclosure at the end of the reaction), and/or
to rinse the by-products formed following the corrosion reaction of the oxidizable material with water.

The collection system 4 allows:
on the one hand to filter the outlet gases from the reaction enclosure in order to separate the water vapor from the hydrogen contained in the outlet gas from the reaction enclosure, and
on the other hand to convey the hydrogen to a receptacle 5 (such as a bottle) for its storage.

The oxidizable material may be selected from a metal—such as magnesium or silicon or aluminum—or a metal alloy—such as an alloy 1050 or an alloy 4032 or an alloy 4043 or an alloy 6060 or an alloy 2017 (or any other metal alloy known to the person skilled in the art). This allows to limit the costs of producing hydrogen. Of course, other oxidizable materials known to the person skilled in the art can also be used. In the following, the invention will be presented with reference to the use of aluminum as an oxidizable material, it being understood that the device and the method according to the invention are not limited to the use of aluminum to produce hydrogen.

“Alkaline aqueous solution” means, in the context of the invention, an aqueous solution whose pH is greater than 7. This alkaline aqueous solution is for example composed of pure water and one (or more) alkali(s).

The alkali(s) may for example be selected from sodium hydroxide (soda), potassium hydroxide (potash), lithium hydroxide, ammonium hydroxide (ammonia).

Advantageously, when the oxidizable material consists of Magnesium or one of its alloys, sodium chloride and/or potassium chloride can be used instead of the alkali (or alkalis).

In the following, the invention will be presented with reference to the use of sodium hydroxide, it being understood that the device and the method according to the invention are not limited to the use of sodium hydroxide to produce hydrogen.

In the context of the invention, “pure water” is defined as water containing water molecules H₂O, and possibly traces of mineral salts. Thus, in the context of the invention, distilled water or demineralized water is considered to be pure water, in the same way as osmosis water.

### 2. Reaction Enclosure

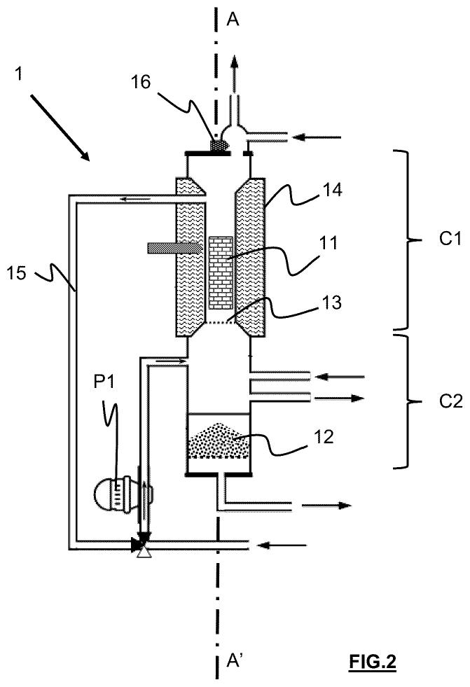

With reference to FIG. 2, the reaction enclosure 1 is configured to contain the reagents, namely:
aluminum 11 (oxidizable material),
the alkaline aqueous solution composed of water and sodium hydroxide (alkali).

It is suitable for withstanding pressures greater than 30 bars, in particular greater than 60 bars. In particular, the reaction enclosure is adapted to withstand pressures greater than 150 bars, preferably greater than 200 bars, and even more preferably greater than 350 bars. Moreover, the reaction enclosure 1 is configured to resist corrosion. Finally, the corrosion reaction of the aluminum 11 being exothermic, the reaction enclosure 1 is configured to withstand temperatures greater than or equal to 200° C. To meet these different constraints, the material constituting the reaction enclosure 1 can be Nickel, or a Nickel alloy.

The corrosion reaction of aluminum 11 with water in the presence of sodium hydroxide induces the production of aluminum oxides and hydroxides. The reaction enclosure 1 is configured to cause the precipitation of these aluminum oxides and hydroxides in the form of aluminates 12, and to contain these aluminates 12.

For this purpose, the reaction enclosure 1 comprises first and second gas-tight chambers C1, C2:
the first chamber C1—called the “reaction chamber”—delimits a zone in which the corrosion reaction of the aluminum 11 by the alkaline aqueous solution is carried out,
the second chamber C2—called the “settling chamber”—delimits a zone in which the aluminum oxides and hydroxides precipitate in the form of aluminates 12.

In the embodiment illustrated in FIG. 2, the reaction chamber C1 is mounted on the settling chamber C2. In particular, the reaction C1 and settling C2 chambers are produced in a single cylindrical housing composed of a bottom, an upper cover and a side wall between the bottom and the cover. The integration of the reaction C1 and settling C2 chambers in the same housing allows to limit the risks of leaks related to a sealing failure in the reaction enclosure 1. This also allows to limit the bulk of the reaction enclosure 1. Advantageously, the reaction chamber C1 can be located above the settling chamber C2 (along a vertical axis A-A′). This allows to avoid the circulation of aluminates in the reaction chamber once they have precipitated: the aluminates are deposited in the settling chamber C2, for example at a removable reservoir to facilitate their extraction from the reaction enclosure 1 at the end of the reaction.

Alternatively, the reaction C1 and settling C2 chambers can be produced in distinct and separate housings, said housings being connected via pipelines to allow the circulation of the reaction fluid between the reaction C1 and settling C2 chambers. This allows in particular to use reaction C1 and settling C2 chambers of different shapes and dimensions. This also allows to reduce the height of the reaction enclosure 1.

Advantageously, the reaction chamber C1 may comprise a heat accumulator 14 extending over the side wall(s) of the reaction chamber C1. This allows to limit the risks of an increase in temperature in the reaction enclosure 1 beyond 250° C.

Indeed, such a heat accumulator 14 is capable of:
absorbing the energy dissipated in the form of heat during the corrosion reaction of aluminum 11, in particular when the temperature in the reaction chamber C1 increases and reaches a temperature threshold,
restoring in the form of heat the energy absorbed when the temperature in the reaction chamber C1 decreases below the temperature threshold.

Thus, the heat accumulator 14 allows:
to store thermal energy during the corrosion reaction of the aluminum 11 with water in order to limit the heating of the walls of the reaction enclosure 1, and
to return it later.

In certain variant embodiments, the heat accumulator 14 may comprise:
a partition intended to be in thermal contact with the side wall(s) of the reaction chamber C1, the partition including a lower panel, an upper panel and a pair of side panels between the lower and upper panels,
a phase change material (or PCM) contained in the partition.

PCM is a material capable of changing physical state (solid/liquid) within a restricted temperature range (for example between 200° C. and 250° C.). Thus, PCM has the particularity of going from the liquid state to the solid state at a temperature close to 200° C. The solidification reaction (that is to say transition from the liquid state) to the solid state is exothermic. The liquefaction reaction (transition from the solid state to the liquid state) is endothermic. The integration of such a heat accumulator 14 therefore allows better control of the temperature inside the reaction enclosure 1.

The reaction enclosure 1 also comprises a stirring unit to promote the circulation of the reaction fluid between the reaction chamber C1 and the settling chamber C2.

In the embodiment illustrated in FIG. 2, the stirring unit consists of a centrifugal pump P1 connected to the reaction chamber C1 and to the settling chamber C2 via a circulation channel 15. In particular, the centrifugal pump P1 is arranged so as to:
pump the reaction fluid into an upper part of the reaction chamber C1, and to
inject the reaction fluid thus pumped into an upper part of the settling chamber C2.

For this purpose, the reaction chamber C1 comprises a first tubular access member disposed in its upper part (that is to say closer to the cover of the housing than the grid of the housing), and the settling chamber C2 comprises a second tubular access member disposed in its upper part (that is to say closer to the grid of the housing than to the bottom of the housing). The centrifugal pump P1 is connected to the reaction C1 and settling C2 chambers so as to:
suck up the reaction fluid contained in the reaction chamber C1 at the first access member, and
discharge the reaction fluid into the settling chamber at the second access member.

Alternatively, the stirring unit may consist of a propeller including a shaft and two (or four) blades at one end of the shaft, the other end of the shaft being connected to a motor to induce the rotation of the propeller shaft and blades. In this case, the propeller is directly immersed in the housing, between the reaction C1 and settling C2 chambers.

Advantageously, the dimensions of the reaction C1 and settling C2 chambers as well as the characteristics of the stirring unit are selected so that:
the speed of circulation of the reaction fluid in the reaction chamber C1 is comprised between 5 and 15 cm/s, preferably 6 and 15 cm/s, and even more preferably between 6 and 10 cm/s,
the speed of circulation of the reaction fluid in the settling chamber is comprised between 0.1 and 4 cm/s, preferably 1 and 3 cm/s, and even more preferably between 2 and 3 cm/s.

The fact that, in the reaction chamber C1, the circulation speed of the reaction fluid is greater than or equal to 5 cm/s (preferably greater than or equal to 6 cm/s) allows to promote the evacuation of the by-products of the corrosion reaction of the aluminum outside the reaction chamber (and therefore limits the risk of slowing down the corrosion reaction due to the alumina).

The fact that, in the settling chamber C2, the circulation speed of the reaction fluid is less than or equal to 4 cm/s (preferably less than or equal to 3 cm/s) allows:
on the one hand to promote the precipitation of the sodium aluminate formed during the aluminum corrosion reaction, and
on the other hand, to promote the separation (by settling) of the solid particles (alumina) contained in the reaction fluid; the solid particles 12 thus separated are advantageously collected in a base of the settling chamber C2.

To obtain different circulation speeds between the reaction chamber and the settling chamber (and in particular speeds of the order of 6 cm/s in the reaction chamber and 3 cm/s in the settling chamber), the diameter of the reaction chamber can be reduced relative to the diameter of the settling chamber (in the case of cylindrical chambers).

This reduction in diameter in the reaction chamber can be obtained:
either by local reduction of the diameter of the reaction enclosure housing,
either by inserting an insert into the housing (for example PTFE insert of cylindrical shape including a through channel of reduced diameter extending along its axis of revolution).

In certain embodiments, the settling chamber C2 may comprise a cyclone (or hydrocyclone) separation system to promote the separation of the reaction fluid from the solid particles it contains. Such a cyclone separation system (not shown) is known to the person skilled in the art and will not be described in more detail below.

Optionally, a cooling unit can be mounted on the walls of the settling chamber C2 to reduce the temperature of the reaction fluid. This allows to promote the precipitation of aluminum oxides and hydroxides contained in the reaction fluid in the form of aluminates 12.

The reaction enclosure 1 comprises an oxidizable material support for carrying the oxidizable material. In the embodiment illustrated in FIG. 2, the support consists of a grid 13 separating the reaction chamber C1 and the settling chamber C2, and the through openings of which allow the passage of the reaction fluid between the settling chamber C2 and the reaction chamber C1. In other embodiments, the oxidizable material support may consist of a removable pillar, one of the ends of which rests on the bottom of the housing, and the free end of which extends into the reaction chamber, at the interface between the reaction chamber C1 and the settling chamber C2.

Advantageously, the reaction enclosure may comprise a filling sensor 16 placed between the reaction chamber C1 and the collection system 4. The filling sensor 16 allows to detect the presence of alkaline aqueous solution. Its positioning allows to indicate, to the control unit, the instant at which the maximum volume of alkaline aqueous solution that the reaction enclosure 1 can contain is reached, in particular when filling the reaction enclosure 1 with the alkaline aqueous solution 21, as will be described in more detail below.

### 3. Alkaline Aqueous Solution Feed System

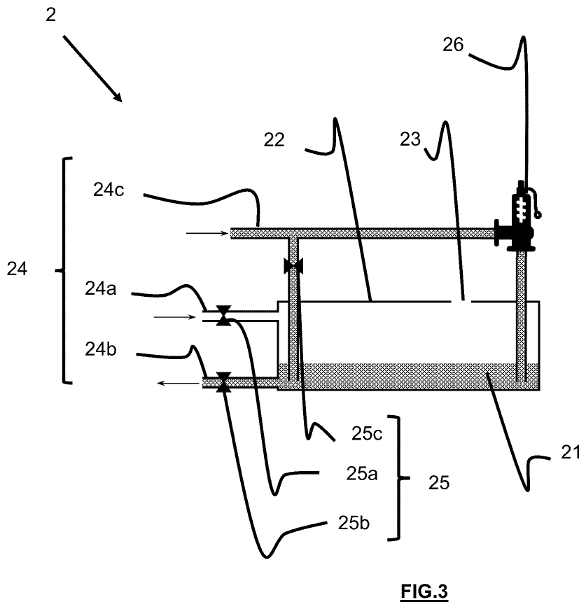

With reference to FIG. 3, the feed system 2 is configured to:
fill the reaction enclosure 1 with the alkaline aqueous solution 21 at the start of the reaction, and to
store the alkaline aqueous solution 21 at the end of the reaction.

The alkaline aqueous solution 21 may comprise water mixed with sodium hydroxide (NaOH) or potassium hydroxide (KOH) with a concentration between 0.5% and 20%.

The feed system 2 comprises a tank 22 adapted to contain the alkaline aqueous solution 21. This tank 22 can have different shapes and be made of different materials capable of resisting corrosion (such as Nickel or a Nickel alloy).

The tank 22 is brought to atmospheric pressure via a vent opening 23 formed in the upper wall of the tank 22. This opening 23 allows to avoid the formation of a depression in the tank 22 when the alkaline aqueous solution 21 is injected into the reaction enclosure 1 at the start of the reaction. The opening 23 also allows the filling of the tank 22 with the alkaline aqueous solution, as will be described in more detail below.

The feed system 2 also comprises one (or more) conduit(s) 24 allowing fluid communication between the tank 22 and the reaction enclosure 1. Each conduit 24 can be associated with an electrically controllable circulation valve 25 (that is to say solenoid valve) to authorize (when the circulation valve 25 is in an open state) or prevent (when the circulation valve 25 is in a closed state) the passage of the alkaline aqueous solution 21 between the tank 22 and the reaction enclosure 1. This ensures:
filling the reaction enclosure 1 with the alkaline aqueous solution 21 at the start of the reaction,
draining the reaction enclosure 1 of the alkaline aqueous solution 21 at the end of the reaction.

In the embodiment illustrated in FIG. 3, the feed system 2 comprises first, second and third conduits 24a, 24b, 24c associated respectively with first, second and third circulation valves 25a, 25b, 25c:
the first conduit 24a (associated with the first circulation valve 25a) allows the passage of the alkaline aqueous solution from the reaction enclosure 1 to the tank 22; this first conduit 24a allows the reaction enclosure 1 to be drained at the end of the reaction,
the second conduit 24b (associated with the second circulation valve 25b) allows the passage of the alkaline aqueous solution from the tank 22 to the reaction enclosure 1; this second conduit 24b allows the reaction enclosure 1 to be filled at the start of the reaction,
the third conduit 24c (associated with the third circulation valve 25c) allows the purge of the various tubes of the installation when filling the reaction enclosure 1.

With reference to FIG. 3, the feed system 2 does not have a circulation pump. Indeed, in this embodiment, it is the centrifugal pump P1—forming stirring unit of the reaction enclosure 1—which ensures the movement of the alkaline aqueous solution 21 through the conduit(s) 24:
between the tank 22 and the reaction enclosure 1 at the start of the reaction, and
between the reaction enclosure 1 and the tank 22 at the end of the reaction.

Alternatively, the feed system 2 may include a pump—for example of the peristaltic pump or roller pump type—for circulating the alkaline aqueous solution 21 between the tank 22 and the reaction enclosure 1.

Of course, the feed system 2 may comprise other components known to the person skilled in the art such as:
a safety valve 26 to limit the risk of overpressure in the tank 22,
a hatch (not shown) for the introduction of sodium hydroxide or potassium hydroxide, for example packaged in the form of pellets,
a purge hole (not shown) to empty the alkaline aqueous solution 21 contained in the tank 22, etc.

### 4. Pure Water Supply System

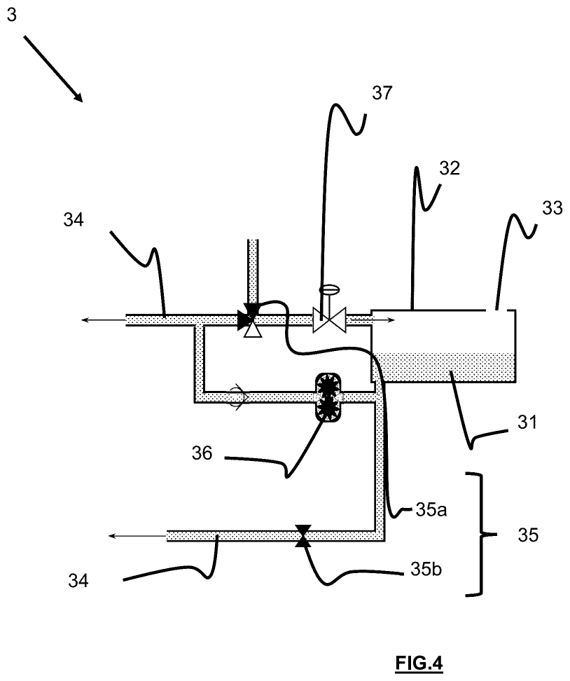

With reference to FIG. 4, the supply system 3 is configured to:
inject pure water into the reaction enclosure 1 at the end of the reaction:
   in order to eliminate a gaseous sky formed above the reaction fluid during the corrosion reaction of the oxidizable material, and/or
   in order to rinse the residual oxidizable material remaining at the end of the reaction, and/or
   in order to rinse the aluminates 12 (solid by-products) separated from the reaction fluid and collected in the base of the settling chamber,
recover pure water 31 from the collection system 4 during the filtering of the gases produced in the reaction enclosure 1 during the aluminum corrosion reaction.

The supply system 3 comprises a tank 32 configured to contain the pure water 31. This tank 32 can have different shapes and be made of different materials such as steel, aluminum or plastic.

The tank 32 is brought to atmospheric pressure via an vent lumen 33. This lumen 33 allows to avoid the formation of a depression in the tank 32 when the pure water 31 is injected into the reaction enclosure 1, or of an overpressure in the tank when pure water is introduced therein.

The supply system 3 also comprises one (or more) pipe(s) 34 allowing fluid communication of the tank 32 with the reaction enclosure 1, each pipe 34 being associated with an electrically controllable valve 35 to authorize or not the passage of pure water 31 through said pipe 34.

In the embodiment illustrated in FIG. 4, the supply system 3 comprises an inlet valve 35a disposed between the tank 32 and the collection system 4, and an outlet valve 35b between the tank 32 and the reaction enclosure 1:
when the inlet valve 35a is in a passing state (and the outlet valve 35b is in a non-passing state), it allows the passage of pure water (obtained by condensation as will be explained in more detail below) between the collection system 4 and the tank 32 to fill the latter;
when the outlet valve 35b is in a passing state (and the inlet valve 35a is in a non-passing state), it allows the passage of pure water between the tank 32 and the settling chamber of the reaction enclosure, either to compensate for a loss of liquid during the corrosion reaction, or to rinse the by-products at the end of the reaction.

Optionally, the supply system 3 can also include a high pressure transfer pump 36 to ensure the movement of pure water 31 between the tank 32 and the reaction enclosure 1.

Injecting pure water 31 into the reaction enclosure 1 allows:
during the corrosion reaction, to compensate for the loss of water from the reaction fluid,
at the end of the corrosion reaction, to minimize hydrogen losses by “pushing” the gaseous sky towards the collection system 4,
after the corrosion reaction and the draining of the reaction fluid in the tank 22, to rinse the elements contained in the reaction enclosure (remaining aluminum 11, aluminates 12, etc.).

Advantageously, the supply system 3 can comprise a degassing valve 37 to allow the pressure inside the reaction enclosure 1 to be gradually reduced at the end of the reaction, and in particular to return the installation to atmospheric pressure when all the oxidizable material has been consumed.

Of course, the supply system 3 may comprise other components known to the person skilled in the art such as:
a non-return valve on the (or some) pipe(s),
a filling hole to introduce pure water into the installation,
a drainage system, etc.

### 5. Gas Collection System

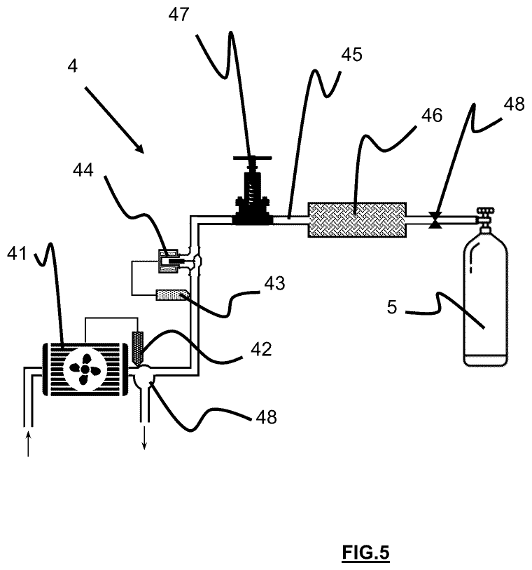

With reference to FIG. 5, the gas collection system is configured to:
recover the gases generated during the corrosion reaction of aluminum 11,
filter said gases to separate the hydrogen from the other compounds contained in the gases generated,
connect the installation to a storage reservoir for the hydrogen produced during the corrosion reaction.

In particular, the collection system 4 is adapted to:
cool the gases generated in the reaction enclosure 1,
condense the water vapor contained in said gases, and return the pure water thus condensed:
   in the reaction enclosure 1 during the implementation of the corrosion reaction (hydrogen production step), or
   in the tank 32 of the supply system 3 at the end of the reaction.

For filtering the gases generated by the corrosion reaction of the aluminum 11, the collection system comprises a heat exchanger 41 to cool the gases generated in order to extract the water vapor.

The heat exchanger 41 is configured to withstand high pressures (pressures greater than 30 bars, in particular greater than 60 bars, preferably greater than 150 bars, more preferably greater than 250 bars and even more preferably greater than 350 bars), and high temperatures (temperatures greater than or equal to 200° C., in particular greater than or equal to 250° C.). The heat exchanger 41 is for example of the air-cooled type.

For example, the heat exchanger 41 may comprise:
a coil (not shown) inside which the gases coming from the reaction enclosure 1 circulate, the external faces of the walls of the coil including cooling fins,
a blower (not shown)—such as a fan—can promote heat exchange between the gases circulating in the coil and the outside air.

Alternatively, the heat exchanger 41 can be of the heat transfer fluid cooling type.

The collection system 4 also comprises a temperature sensor 42 in communication with the control unit (not shown) of the installation, the control unit activating the heat exchanger 41 when the temperature measured by the temperature sensor 42 is greater than a predefined threshold value (for example 50° C.).

The heat exchanger 41 allows to condense the water vapor contained in the gases leaving the reaction enclosure 1 to form pure liquid water. This pure liquid water (or condensate) is separated from the hydrogen using a condensate separator 48 placed at the outlet of the heat exchanger 41.

During the corrosion reaction, the pure liquid water is reintroduced into the reaction chamber C1 of the reaction enclosure 1. At the end of the corrosion reaction, the pure water is reintroduced into the tank 32 of the supply system 3.

For this purpose, the heat exchanger 41 is in fluid communication—via one (or more) pipeline(s)—with the reaction enclosure 1 on the one hand, and with the supply system 3 on the other hand, one (or more) controlled orientation valve(s) (for example one (or more) solenoid valve(s)) arranged along the pipeline(s) allowing to direct the circulation of the condensed water to the reaction enclosure 1 or to the supply system 3.

Optionally, the collection system 4 may comprise a liquid sensor 43 and a controlled safety valve 44 downstream of the heat exchanger 41. The liquid sensor 43 and the safety valve 44 are configured to communicate with the control unit.

In particular:
the liquid sensor 43 allows to detect the presence of corrosive liquid downstream of the heat exchanger 41; when a corrosive liquid is detected by the liquid sensor 43, it transmits a signal to the installation control unit,
the safety valve 44 allows to open or close a passage to the storage receptacle 5 of the hydrogen produced:
   if a corrosive liquid is detected by the liquid sensor 43, the control unit controls the closing of the safety valve 44 to prevent the propagation of said corrosive liquid towards the storage receptacle 5,
   if no corrosive liquid is detected by the liquid sensor 43, the control unit controls the opening of the safety valve 44 to allow the passage of gases to the storage receptacle 5.

The presence of a liquid sensor 43 associated with a safety valve 44 the opening and closing of which are controlled by the controller allows to limit the risks of degradation of the storage receptacle with corrosive liquid.

To allow the circulation of gases between the heat exchanger 41 and the storage receptacle 5, the collection system 4 comprises a gas circulation conduit 45 connected to the heat exchanger 41 on the one hand and to the storage receptacle 5 on the other hand.

However, before being stored in the storage receptacle 5, the hydrogen must be treated to have a given purity and/or a given humidity level which depend on the technical specifications of the storage receptacle 5 and/or the intended application. This is why the collection system 4 comprises a gas purifier 46 mounted along the gas circulation conduit 45 between the heat exchanger 41 and the storage receptacle 5. This purifier 46 can contain a desiccant product (silica gel type, CaO, CaCl₂ or others), and/or an activated carbon, and/or a particle filter, and/or a hydrophobic membrane, and/or a palladium membrane, etc.

Advantageously, the collection system 4 may include a discharger 47 (or pressure reducer) mounted along the gas circulation conduit 45. This discharger 47 allows to regulate the pressure of the gas in the collection system 4 in order to make it correspond to the desired pressure for the storage receptacle 5 (for example storage of hydrogen at a pressure of 150 bars, or 200 bars, or 350 bars, etc.).

Finally, the collection system 4 may include an isolation valve 48 downstream of the purifier 46 to (manually or automatically) open/close the passage between the purifier 46 and the storage receptacle 5. This allows to close the gas circulation conduit 45 in order to disconnect the storage receptacle when it is full and replace it with an empty storage receptacle.

### 6. Principle of Operation

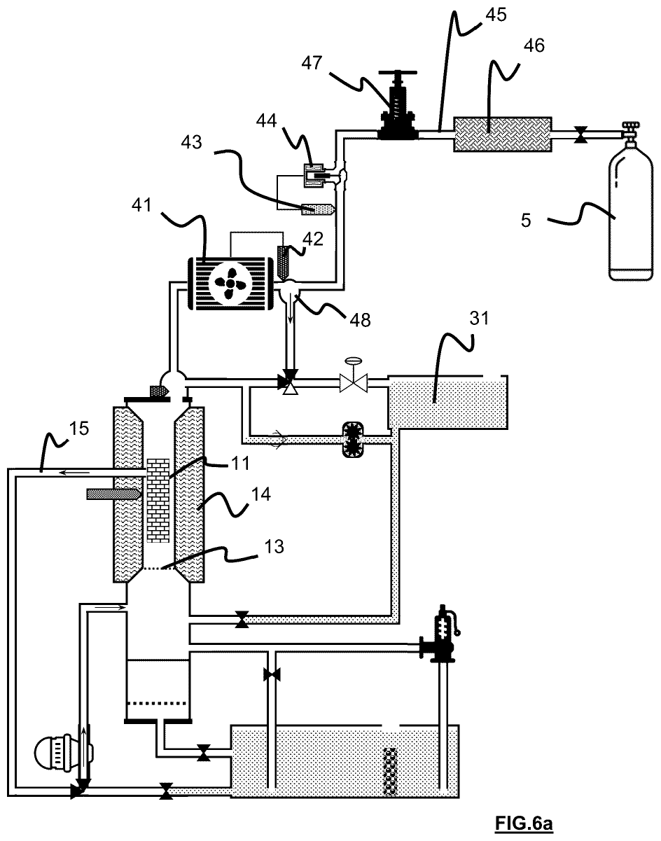

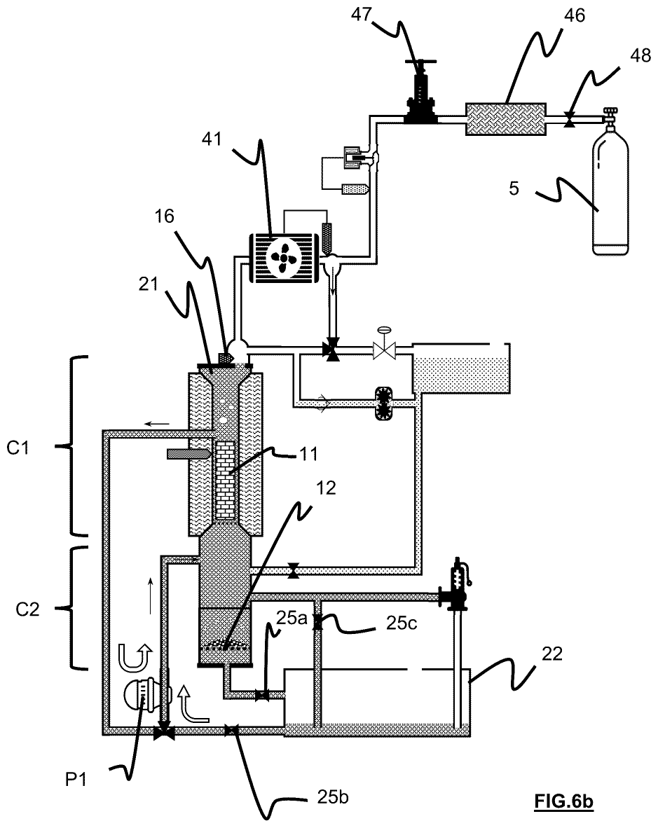

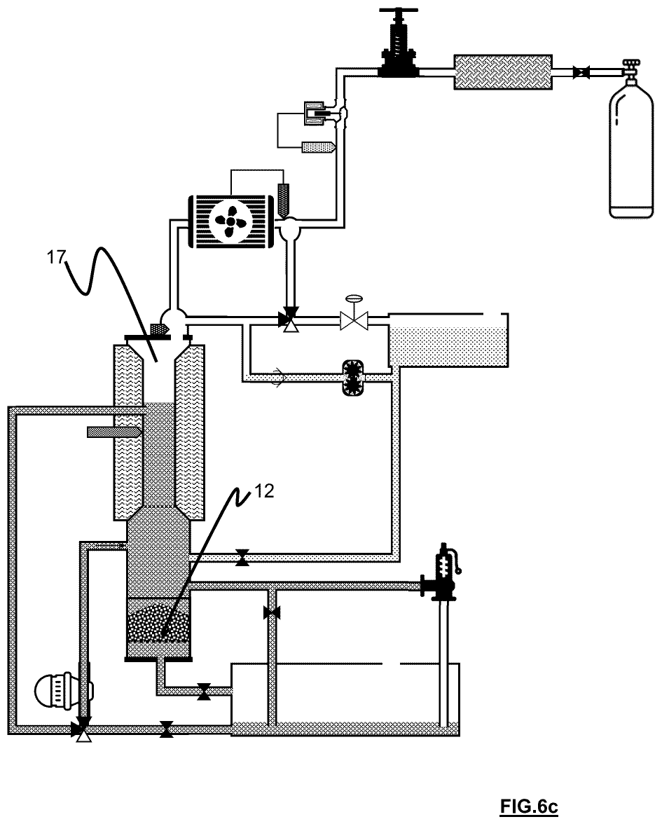

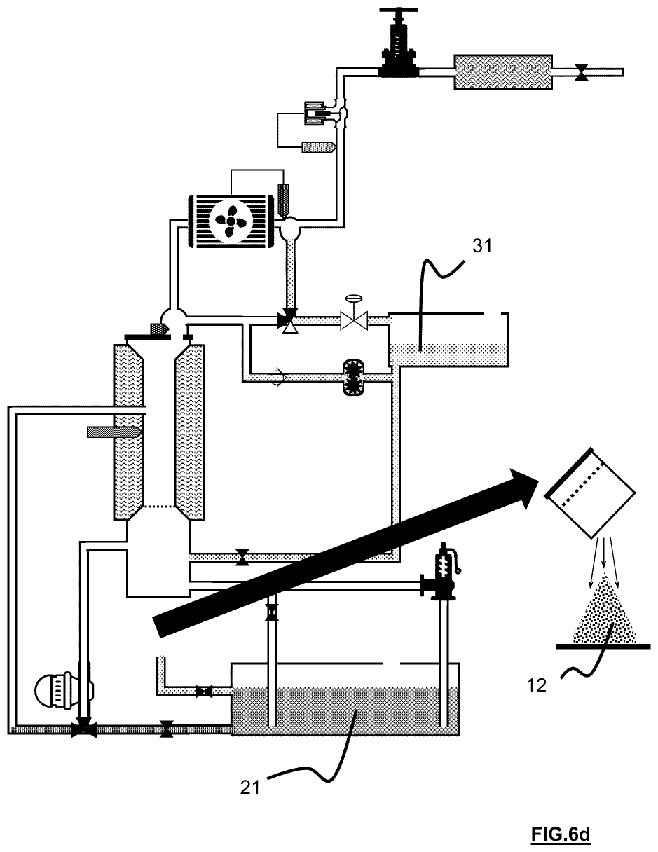

The principle of operation of the hydrogen production installation will now be described with reference to FIGS. 6a to 6d.

### 6.1. Preparation

A first phase of the hydrogen production method relates to the preparation of the installation, and in particular its loading for the implementation of the corrosion reaction.

### 6.1.1. Formulation of the Alkaline Aqueous Solution

When the installation has not yet been used, a first step in the preparation phase relates to the formulation of the alkaline aqueous solution. For this purpose:
the tank 22 of the feed system is filled with pure water, for example through the vent opening 23, and
sodium hydroxide (for example packaged in the form of one or more pellets) is introduced into the tank 22, for example through the opening 23.

Pure water and sodium hydroxide are mixed to form the alkaline aqueous solution.

When implementing the formulation step, the first and second circulation valves 25a, 25b are in a closed state to maintain the alkaline aqueous solution in the tank 22.

Advantageously, the formulation step is only implemented once during the first use of the installation, the alkaline aqueous solution being reusable at the end of the corrosion reaction.

### 6.1.2. Pure Water Supply

The preparation phase also comprises a step of supplying pure water in the tank 32 of the supply system.

This step of supplying pure water may consist of:
completely filling the tank with pure water when the installation has not been used, or
adding pure water to the tank 32 to upgrade the amount of pure water contained in the tank in the event of reuse of the installation.

Whether it is the first filling or an upgrade, pure water can be introduced into the supply system at the lumen 33 formed in the upper wall of the tank 32.

### 6.1.3. Inserting the Consumable

The preparation phase also comprises a step of loading the enclosure with the oxidizable material (aluminum, etc.) necessary for the formation of hydrogen.

The oxidizable material may have the shape of a block. It is introduced into the reaction chamber C1 and placed on the support of the reaction enclosure 1 to allow it to be maintained in position during the corrosion reaction carried out subsequently.

### 6.2. Corrosion Reaction

With reference to FIG. 6b, a second phase of the method relates to the corrosion reaction. This corrosion reaction phase is broken down into different steps:
a start-up step in which the different reagents are mixed in the reaction enclosure 1,
a hydrogen generation step composed of a transient regime and a quasi-stationary regime succeeding the transient regime,
a finishing step during which different actions are implemented in particular for the recovery of hydrogen, and/or the rinsing of reaction by-products.

### 6.2.1. Start-Up

To initiate the corrosion reaction, the different reagents are mixed in the reaction enclosure 1 which contains the oxidizable material.

Particularly during the start-up step, the reaction enclosure 1 is filled with the alkaline aqueous solution 21. For this purpose, the second circulation valve 25b is switched to a passing state to allow the circulation of the alkaline aqueous solution 21 from the tank 22 towards the reaction enclosure 1. The movement of the alkaline aqueous solution 21 can be ensured by any means known to the person skilled in the art (gravity, activation of a pump, etc.). In the embodiment illustrated in FIG. 6b, the movement of the alkaline aqueous solution is ensured by the activation of the centrifugal pump P1. During the sub-step of filling the reaction enclosure 1 with the alkaline aqueous solution 21, the circulation valves 25a, 25c are occasionally opened (passing state) to expel the air contained in the different lines (that is to say circulation channel 15, conduits 24, etc.) of the reaction enclosure 1 and the supply system 3. Moreover, during the filling sub-step, the isolation valve 48 is closed (non-passing state) to prevent the air contained in the installation from entering the storage receptacle 5 intended to contain the hydrogen produced. When the filling sensor 16 detects the presence of alkaline aqueous solution 21, then the reaction enclosure 1 is completely filled: the maximum volume of alkaline aqueous solution 21 that the reaction enclosure 1 can contain is reached. The filling sensor 16 emits a signal to the control unit which controls the closing of the second circulation valve 25b (switching to a non-passing state) to prevent the circulation of the aqueous solution between the tank 22 and the reaction enclosure 1.

Once the reaction enclosure is completely filled with the alkaline aqueous solution, the corrosion reaction starts and hydrogen is produced: the isolation valve 48 is opened (either manually or automatically by the control unit) to allow the circulation of the hydrogen produced between the collection system 4 and the storage receptacle 5.

### 6.2.2. Hydrogen Generation

The corrosion reaction of the oxidizable material begins: hydrogen is continuously generated, the reaction solution circulates in the reaction enclosure 1 between the reaction C1 and settling C2 chambers.

The pressure and temperature in the reaction enclosure 1 gradually increase. When the pressure in the reaction enclosure 1 (and in the gas collection system 4) reaches the desired pressure for the storage receptacle 5 (for example 150 bars, 200 bars, 250 bars, 300 bars or 350 bars), the discharger 47 opens and allows the hydrogen to circulate in the gas purifier 46 and then in the storage receptacle 5.

At the outlet of the gas purifier 46, the hydrogen is dry:
on the one hand due to the fact that the residual humidity contained in the gases leaving the heat exchanger 41 is expelled by the humidity absorber contained in the purifier, and
on the other hand due to the fact that the amount of water vapor in the gas for a given temperature is determined by the ratio of the partial pressures of the gas and the water vapor for this temperature, while the partial pressure of the vapor water depends only on temperature; thus, at high gas pressure (for example 200 atmospheres) and relatively low temperature (for example 50 degrees Celsius), the partial pressure of water vapor will be low (˜0.12 bar or 0.06% of the partial pressure of hydrogen); it is concluded that the hydrogen leaving the gas purifier 46 contains a very small amount of water vapor: 0.06% water vapor and 99.94% hydrogen.

During the corrosion reaction of aluminum 11 with the alkaline aqueous solution 21, hydrogen, aluminum oxides and aluminum hydroxides are produced in the reaction chamber C1. The hydrogen escapes to the gas collection system 4, while the aluminum oxides and hydroxides are transported in the reaction fluid to the settling chamber C2 where they precipitate in the form of aluminates 12. The hydrogen which is evacuated towards the collection system 4 is saturated with water vapor and has a very high temperature. As it passes through the heat exchanger, the hydrogen is cooled (to approximately 60° C.) and the excess water vapor it contains is condensed into pure liquid water. This pure liquid water is reintroduced into the reaction chamber C1 of the reaction enclosure 1.

### 6.2.3. End of Reaction

At the end of the reaction, and as illustrated in FIG. 6c:
the oxidizable material 11 has been consumed, and
the by-products 12 are found in the lower part of the settling chamber C2.

As the corrosion reaction consumes water molecules, the level of alkaline aqueous solution contained in the reaction enclosure 1 is lower at the end of the reaction than at the start of the reaction.

As a result, a gas pocket 17—called “gaseous sky”—at high pressure containing approximately 30% of hydrogen produced during the reaction is present in the reaction chamber C1.

### 6.2.3.1. Recovery of Hydrogen Contained in the Gaseous Sky

In order to improve the yield of the reaction, the method can comprise a sub-step consisting of recovering the hydrogen contained in this gaseous sky.

A first solution for recovering the hydrogen contained in the gaseous sky 17 consists of injecting pure water into the reaction enclosure from the supply system 3. For this purpose, the transfer pump 36 is activated and the outlet valve 35b is switched to a passing state to allow the transfer of pure water at high pressure from the tank 32 to the settling chamber C2 of the reaction enclosure 1. This induces the movement of the gaseous sky towards the gas collection system 4 for the recovery of the hydrogen contained therein.

A second solution for recovering part of the hydrogen contained in the gaseous sky 17 consists of:
switching the isolation valve 48 into a blocked state to replace the storage receptacle in which the produced hydrogen was stored with an empty storage receptacle, and of
switching the isolation valve 48 into a passing state once the empty storage receptacle is connected.

This second solution allows to recover approximately 75% of the hydrogen contained in the gaseous sky 17.

### 6.2.3.2. Restoration to Operating Condition

A sub-step of restoring the installation to operating condition can also be implemented.

This restoration sub-step comprises
cooling and bringing the installation to atmospheric pressure,
purging the installation to empty the alkaline aqueous solution contained in the reaction enclosure,
rinsing the reaction by-products 12,
recovering reaction by-products 12.

For cooling and bringing the installation to atmospheric pressure, the inlet valve 35a of the supply system 3 is switched to a state allowing the circulation of pure water between the collection system 4 and the supply system 3. Thus, from this switching of the inlet valve 35a, all the condensed water vapor (forming pure water) by the heat exchanger is routed to the tank 32. Moreover, the degassing valve 37 is opened gradually to allow the gases to escape through the tank 32 which is at atmospheric pressure. This allows to reduce the pressure inside the reaction enclosure on the one hand and the collection system on the other hand. After an initial loss of pressure, the reaction solution begins to boil, actively evaporating some water and lowering the temperature. The water vapors are condensed in the heat exchanger 41 of the collection system 4 and the condensate thus obtained is reintroduced into the tank 32 of the supply system 3.

To purge the installation, the control unit activates the first circulation valve 25a to switch it into a passing state in order to allow the passage of the alkaline aqueous solution from the reaction enclosure 1 to the tank 22. The circulation of the alkaline aqueous solution between the chambers C1, C2 and the tank 22 can be provided by gravity or obtained by motorized action (using a pump). The alkaline aqueous solution thus purged can be reused subsequently to carry out a new corrosion reaction. This allows to limit the amount of soda used for the generation of hydrogen.

For rinsing the by-products, pure water from the supply system 3 can be poured into the settling chamber C1. This allows to rid the by-products 12 of any soda deposits present on their surfaces. The rinsing water is recovered in the tank 22 of the feed system 2. Here again, this rinsing allows to limit the amount of soda used for the generation of hydrogen (in addition to cleaning the reaction by-products).

The lower part of the settling chamber is then detached to evacuate the solid by-products of the reaction.

### 6.3. Conclusions

The installation described above allows to generate hydrogen by:
maximizing the amount of oxidizable material consumed,
minimizing the amounts of water and soda consumed.

This installation also allows the generation of hydrogen at high pressure (up to 350 bars).

The reader will have understood that numerous modifications can be made to the invention described above without materially departing from the new teachings and advantages described here.

1. An installation for the production of dihydrogen comprising:
a reaction enclosure intended to contain an oxidizable material,
an alkaline solution feed system fluidly connected to the reaction enclosure,
a pure water supply system fluidly connected to the reaction enclosure,
a dihydrogen collection system downstream of the reaction enclosure, wherein the dihydrogen collection system is fluidly connected:
on the one hand to the reaction enclosure, and
on the other hand to the supply system,
and comprises a terminal for connecting a storage receptacle to the installation, said receptacle being configured to store the dihydrogen produced at a desired high pressure greater than or equal to 60 bars,
wherein the reaction enclosure comprises:
a reaction chamber in which a corrosion reaction of the oxidizable material by the alkaline solution is carried out, wherein said reaction produces a gas containing dihydrogen, and a reaction fluid composed of a mixture of alkaline solution and oxidized material,
a settling chamber in which a precipitation reaction of the oxidized material contained in the reaction fluid is carried out, and
a stirring unit fluidly connected to the reaction chamber and to the settling chamber to ensure the circulation of the reaction fluid between the reaction chamber and the settling chamber, the speed of circulation of the reaction fluid in the reaction chamber being greater than the speed of circulation of the reaction fluid in the settling chamber.

2. The installation according to claim 1, wherein the stirring unit includes a pump, the power of the pump, the dimensions of the reaction chamber and the dimensions of the settling chamber are configured so that:
the circulation speed of the reaction fluid is greater than or equal to 5 cm/s in the reaction chamber, and
the circulation speed of the reaction fluid is less than or equal to 4 cm/s in the settling chamber.

3. The installation according to claim 1, wherein the settling chamber comprises a cyclone separation system.

4. The installation according to claim 1, wherein the dihydrogen collection system is fluidly connected to the reaction chamber of the reaction enclosure to receive the gas produced by the corrosion reaction of the oxidizable material, said dihydrogen collection system comprising a heat exchanger for condensing the water vapor contained in said gases and forming condensed pure water.

5. The installation according to claim 4, wherein the dihydrogen collection system further comprises a liquid sensor and a safety valve mounted between the reaction enclosure and the heat exchanger, and wherein the safety valve is:
in a passing state when no liquid is detected by the liquid sensor so as to allow the circulation of gases between the reaction enclosure and the dihydrogen collection system,
in a blocked state when a liquid is detected by the liquid sensor so as to prevent the circulation of gases from the reaction enclosure to the heat exchanger.

6. The installation according to claim 4, wherein the dihydrogen collection system further comprises a purifier mounted downstream of the heat exchanger to treat the gases coming from the heat exchanger.

7. The installation according to claim 4, wherein the dihydrogen collection system further comprises a spillway downstream of the heat exchanger, said spillway allowing the circulation of gases towards the storage receptacle when the pressure in the dihydrogen collection system is greater than or equal to the desired high pressure.

8. The installation according to claim 4, wherein the dihydrogen collection system comprises an isolation valve, which is:
in a blocked state:
when the storage receptacle needs to be replaced, or
during a start-up phase of the installation in which the reaction enclosure is filled with the alkaline solution,
otherwise in a passing state.

9. The installation according to claim 1, wherein the pure water supply system comprises a tank containing pure water, and a transfer pump between said tank and the reaction enclosure, wherein said transfer pump is configured to:
transfer pure water from the tank to the reaction enclosure during a phase of recovery of dihydrogen contained in a gas pocket located in the reaction enclosure, between the alkaline solution and the dihydrogen collection system,
transfer said pure water at a pressure greater than or equal to the desired high pressure.

10. The installation according to claim 9, wherein the tank is at atmospheric pressure, the supply system comprising a degassing valve (37), wherein said degassing valve is:
in a blocked state during the corrosion reaction of the oxidizable material by the alkaline solution, said reaction producing a gas containing dihydrogen,
in a passing state when the corrosion reaction is completed, to reduce the pressure inside the reaction enclosure and inside the dihydrogen collection system.

11. The installation according to claim 9, wherein the dihydrogen collection system is fluidly connected to the reaction chamber of the reaction enclosure to receive the gas produced by the corrosion reaction of the oxidizable material, said dihydrogen collection system comprising a heat exchanger for condensing the water vapor contained in said gases and forming condensed pure water, and wherein the supply system further comprises:
an inlet valve between the dihydrogen collection system and the tank, wherein said inlet valve is:
in a blocked state during the corrosion reaction of the oxidizable material by the alkaline solution, so that the condensed pure water from the heat exchanger is redirected to the reaction enclosure, in a passing state when the corrosion reaction is completed, to allow the circulation of condensed pure water from the heat exchanger, from the dihydrogen collection system to the tank, and
an outlet valve between the tank and the reaction enclosure, said outlet valve being in a passing state when the corrosion reaction is complete, for rinsing by-products of the corrosion reaction.

12. The installation according to claim 1, wherein the receptacle is configured to store the dihydrogen produced at a desired high pressure greater than 150 bars.

13. The installation according to claim 1, wherein the receptacle is configured to store the dihydrogen produced at a desired high pressure greater than 250 bars.

14. The installation according to claim 1, wherein the receptacle is configured to store the dihydrogen produced at a desired high pressure greater than 350 bars.

15. The installation according to claim 2, wherein the power of the pump, the dimensions of the reaction chamber and the dimensions of the settling chamber are configured so that:
the circulation speed of the reaction fluid is greater than or equal to 6 cm/s in the reaction chamber, and
the circulation speed of the reaction fluid is less than or equal to 3 cm/s in the settling chamber.
